(19) United States
(12) Patent Application Publication
(10) Pub. No.: US 2024/0084813 A1
(43) Pub. Date: Mar. 14, 2024

(54) FAN

(71) Applicants: Inventec (Pudong) Technology Corporation, Shanghai (CN); INVENTEC CORPORATION, TAIPEI CITY (TW)

(72) Inventors: Yi-Lun CHENG, TAIPEI CITY (TW); Chih Kai YANG, TAIPEI CITY (TW)

(21) Appl. No.: 18/067,735

(22) Filed: Dec. 19, 2022

(30) Foreign Application Priority Data
Sep. 13, 2022 (CN) 202211112149.X

(51) Int. Cl. F04D 29/30; F04D 29/28; F04D 29/66

(52) U.S. Cl. CPC F04D 29/30; F04D 29/281; F04D 29/667; F05D 2250/712

(57) ABSTRACT

A fan includes a fan hub and multiple blades. At least one blade includes a blade body and two extended blade portions. The two extended blade portions are connected to a first edge and a second edge on the blade body. The first edge and the second edge are opposite to sides of the blade body. In a top view, at least one of the two extended blade portions has a first width that is adjacent to the fan hub, and a second width that is away from the fan hub. The second width is larger than the first width. The second width and the first width are connected by a continuous surface. The width of the continuous surface increases away from the first width.

### CROSS-REFERENCE TO RELATED APPLICATION

This application claims priority to China Application Serial Number 202211112149.X, filed Sep. 13, 2022, which is herein incorporated by reference in its entirety.

### BACKGROUND

### Field of Invention

The present disclosure relates to a fan.

### Description of Related Art

Traditional heat dissipation fans drive airflow by rotating the blades. The airflow will be brought into the fan from its axial direction, and the airflow will be thrown out of the fan along its radial direction by the centrifugal force of the rotation. The amount of airflow of the fan is limited by the blades. Specifically, the amount of airflow is limited by the size of the blades and the distance between each blade. However, the size of the blades will be limited by their installation space, and changing the distance between each blade needs to consider the balance of the air volume and the wind pressure to the fan. In pursuit of better heat dissipation efficiency, the amount of airflow of the fan should be increased while maintaining the air volume and the wind pressure to the fan.

### SUMMARY

An aspect of the present disclosure is related to a fan.

According to an embodiment of the present disclosure, a fan includes a fan hub and a plurality of blades. At least one of the blades includes a blade body and two extended blade portions. The two extended blade portions connect a first edge and a second edge that is opposite to the first edge of the blade body. In a top view, at least one of the two extended blade portions has a first width that is adjacent to the fan hub and a second width that is away from the fan hub. The second width is larger than the first width. The second width and the first width are connected to each other through a continuous surface. The width of the continuous surface increases away from the first width.

In an embodiment of the present disclosure, the blade body extends along a radial direction of the fan hub. The two extended blade portions extend along a rotation direction of the fan.

In an embodiment of the present disclosure, the blade body has a trench along a radial direction of the fan hub. The opening of the trench is facing the rotation direction of the fan.

In an embodiment of the present disclosure, in a sectional view that is perpendicular to an axial direction of the fan hub, an angle between the two extended blade portions and the blade body is greater than or equal to 90 degrees.

In an embodiment of the present disclosure, the two extended blade portions and the blade body form a smoothed curved surface. The smoothed curved surface has an arc outline in a sectional view that is perpendicular to an axial direction of the fan hub.

In an embodiment of the present disclosure, a first distance is between at least one of the two extended blade portions and the fan hub.

In an embodiment of the present disclosure, a side of the at least one blade that is away from the fan hub extends along an axial direction of the fan hub and connects the first edge and the second edge. The second width is located where the at least one of the two extended blade portions and the side are connected.

In an embodiment of the present disclosure, the blade body and the two extended blade portions form an air collection space. The air collection space of the at least one of the blades extends along a radial direction of the fan.

In an embodiment of the present disclosure, an opening of the air collection space is facing a rotation direction of the fan.

In an embodiment of the present disclosure, the fan further includes a limitation structure. The limitation structure connects the at least one of the blades and another adjacent blade. A second distance is formed between the at least one of the blades and the adjacent blade.

In the aforementioned embodiments of the present disclosure, in the fan of the present disclosure, through the two extended blade portions located on the upper edge and the bottom edge of the fan, the airflow will not run off from the upper edge and the bottom edge, and the amount of airflow and heat dissipation efficiency may be increased. The angle between the extended blade portions and the blade body may be larger than or equal to 90 degrees. The angle may adjust the wind field near the blades, and further decrease the noise produced by the turbulence of the fan. In addition, the extended blade portion located on a side of the blade body that is away from the fan hub may increase the amount of airflow while maintaining the air intake of the fan. The limitation structure may be located on the blade body and connects the first edge and the second edge thus preventing the distance between the blades changes during the operation to maintain the wind field of the fan.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A schematically illustrates a top view of a fan, according to one embodiment of the present disclosure;

FIG. 1B schematically illustrates one of the blades of the fan in FIG. 1A, according to one embodiment of the present disclosure;

FIG. 2A schematically illustrates a top view of a fan, according to another embodiment of the present disclosure;

FIG. 2B schematically illustrates one of the blades of the fan in FIG. 2A, according to another embodiment of the present disclosure;

FIG. 3A schematically illustrates a top view of a fan, according to another embodiment of the present disclosure;

FIG. 3B schematically illustrates one of the blades of the fan in FIG. 3A, according to another embodiment of the present disclosure;

FIG. 4A schematically illustrates a fan with a limitation structure, according to one embodiment of the present disclosure;

FIG. 4B schematically illustrates a top view of the fan after removing the limitation structure in FIG. 4A, according to one embodiment of the present disclosure; and

FIG. 4C schematically illustrates one of the blades of the fan in FIG. 4B, according to one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

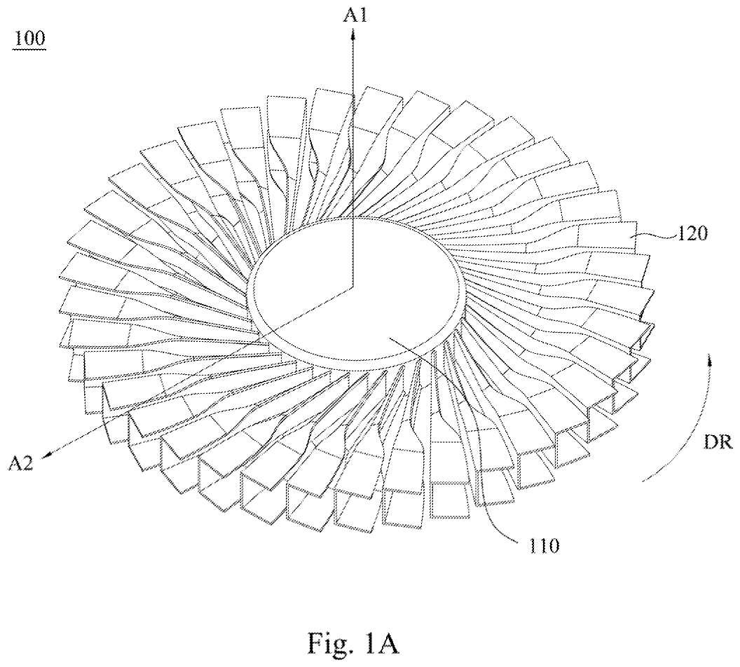

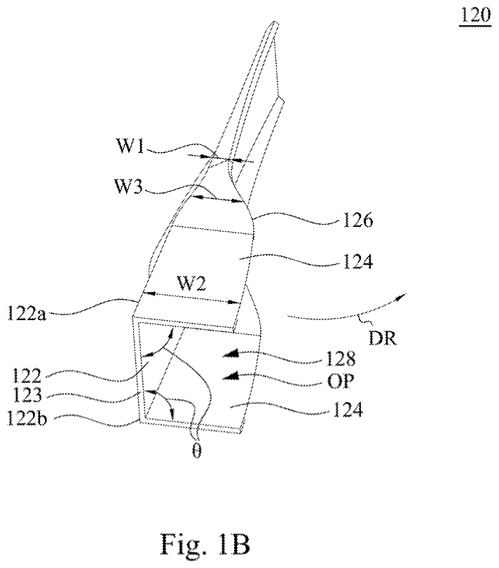

FIG. 1A schematically illustrates a top view of a fan 100, according to one embodiment of the present disclosure. FIG. 1B schematically illustrates one of the blades 120 of the fan 100 in FIG. 1A, according to one embodiment of the present disclosure. A fan 100 includes a fan hub 110 and a plurality of blades 120. At least one of the blades 120 includes a blade body 122 and two extended blade portions 124. The two extended blade portions 124 connect a first edge 122a and a second edge 122b that is opposite to the first edge 122a of the blade body 122. In a top view, at least one of the two extended blade portions 124 has a first width W1 that is adjacent to the fan hub 110 and a second width W2 that is away from the fan hub 110. The second width W2 is larger than the first width W1. The second width W2 and the first width W1 are connected to each other through a continuous surface 126. A width W3 of the continuous surface 126 increases away from the first width W1.

References are made to FIG. 1A and FIG. 1B, in some embodiments, the blade body 122 extends along a redial direction A2 of the fan hub 110. The two extended blade portions 124 extend along a rotation direction of the fan 100. Specifically, in the embodiment shown in FIG. 1A and FIG. 1B, the blades 120 extend outward along the radial direction A2 of the fan hub 110, and the two extended blade portions 124 expand on an end that is away from the fan hub 110. In this embodiment, fan 100 rotates counterclockwise along the axial direction A1, and the two extended blade portions 124 expand facing the rotation direction (which is the counterclockwise direction) of fan 100. In some embodiments, the material for forming the blades 120 may be or includes metals or 3D printing materials. The two extended blade portions 124 may be formed together with the blade body 122 through metal stamping or 3D printing.

References are made to FIG. 1A and FIG. 1B, in some embodiments, the blade body 122 and the two extended blade portions 124 form an air collection space 128. The air collection space 128 of the at least one of the blades 120 extends along a radial direction A2 of the fan 100. Specifically, air collection space 128 may help to collect airflow. The reason is that the two extended blade portions 124 may prevent the airflow that is guided to the air collection space 128 flows out from the upper side and the lower side of the fan 100. Hence, the airflow that is guided to the air collection space 128 may be thrown to an edge of the blade 120 which is away from the fan hub 110, and the air volume of the fan 100 may be increased. In addition, in some embodiments, an opening of the air collection space 128 is facing a rotation direction of the fan 100. Specifically, the opening of the air collection space 128 is defined by the extended direction of the two extended blade portions 124. In this embodiment, the two extended blade portions 124 expand along the rotation direction of fan 100, therefore, the opening of the air collection space 128 is facing the rotation direction of fan 100. When the opening of the air collection space 128 is facing the rotation direction, the airflow may be maintained in the air collection space 128 through the rotation, which may prevent the airflow lost from the opening due to the rotation direction and the opening direction being different.

In some embodiments, in a sectional view that is perpendicular to an axial direction A1 of the fan hub 110, an angle between the two extended blade portions 124 and the blade body 122 is larger than or equal to 90 degrees. For example, the blades 120 shown in FIG. 1A and FIG. 1B, an angel between the two extended blade portions 124 and the blade body 122 is 90 degrees. The angle between the two extended blade portions 124 and the blade body 122 may define the size of the air collection space 128, and further change the air volume of the fan 100 and the wind field near the first edge 122a and the second edge 122b of the blade body 122. The air volume affects the heat dissipation efficiency of the fan 100, and the wind field defines the turbulence near the blades 120. The turbulence may affect the flowing efficiency of the airflow and make fan 100 produces louder noise. The two extended blade portions 124 may prevent the airflow flows out from the upper side and the lower side of the fan 100, and reduce the formation of the turbulence at the first edge 122a and the second edge 122b, and thus reduce the noise of fan 100.

In FIG. 1A and FIG. 1B, the two extended blade portions 124 of the blade 120 have a first width W1 and a second width W2 respectively. In some embodiments, a side of the at least one blades 120 that is away from the fan hub 110 extends along an axial direction A1 of the fan hub 110 and connects the first edge 122a and the second edge 122b. The second width W2 is located where the at least one of the two extended blade portions 124 and the side are connected. Specifically, the first width W1 is at a side of the extended blade portion 124 that is closer to the fan hub 110, the second width W2 is at a side of the extended blade portion 124 that is away from the fan hub 110, and the second width W2 is larger than the first width W1. The reason that the first width W1 is shorter than the second width W2 is related to the inlet of the fan 100. The inlet of fan 100 is the adjacent area near the rotation axis (for example, the area near the fan hub 110.) The first width W1 becomes narrower relative to the blade body 122 as it approaches the fan hub 110, hence the inlet of fan 100 thus can maintain its air intake. The reason that the second width W2 is larger than the first width W1 is related to the volume of the air collection space 128. With a larger second width W2, the volume of the air collection space 128 may increase. Moreover, fan 100 with longer extended blade portions 124 may further prevent the formation of turbulence.

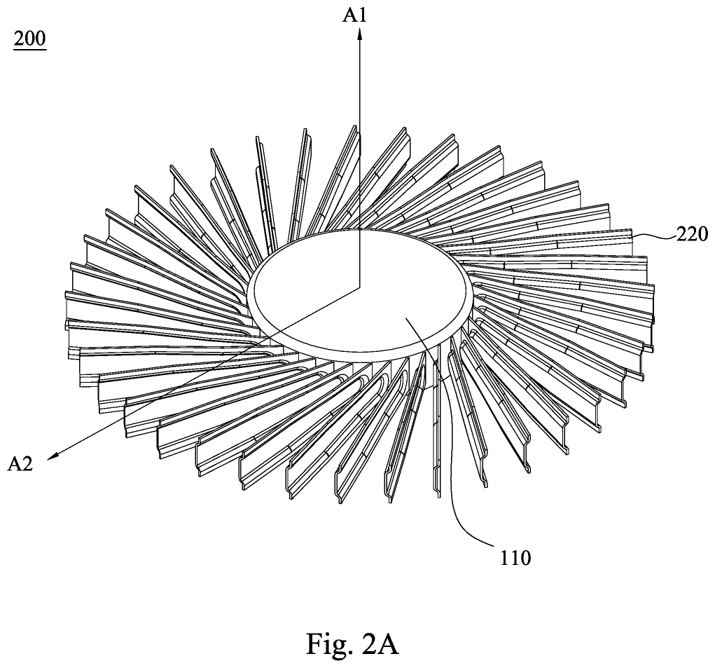

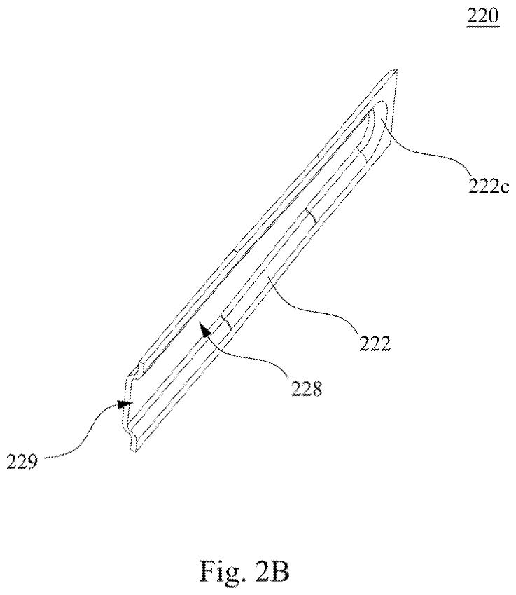

FIG. 2A schematically illustrates a top view of a fan 200, according to another embodiment of the present disclosure. FIG. 2B schematically illustrates one of the blades 220 of the fan 200 in FIG. 2A, according to another embodiment of the present disclosure. References are made to FIG. 2A and FIG. 2B, in this embodiment, fan 200 includes a fan hub 110 and multiple blades 220. The blade body 222 has a trench 229 along a radial direction A2 of the fan hub 110. An opening of the trench 229 is facing a rotation direction of the fan 200. Specifically, the material for forming the blades 220 of fan 200 may be or includes metals or 3D printing materials. The formation of the blade body 222 and the trench 229 may be similar to the embodiment shown in FIG. 1A and FIG. 1B. The trench 229 may be formed together with the blade body 222 through apply metal stamping on the blade 220 or by 3D printing. The trench 229 forms an air collection space 228 on the blade body 222. In this embodiment, the airflow enters the air collection space 228 through trench 229 and soon afterward the airflow is thrown out of fan 200 along trench 229. References are made to FIG. 2A and FIG. 2B. In this embodiment, the depth of trench 229 does not change while getting away from the fan hub 110. However, the present disclosure is not limited to this. Trench 229 has a curved surface near the fan hub 110, the curved surface connects trench 229 to the blade body 222 through a slope 222c, and the slope 222c may help to guide the airflow entering trench 229.

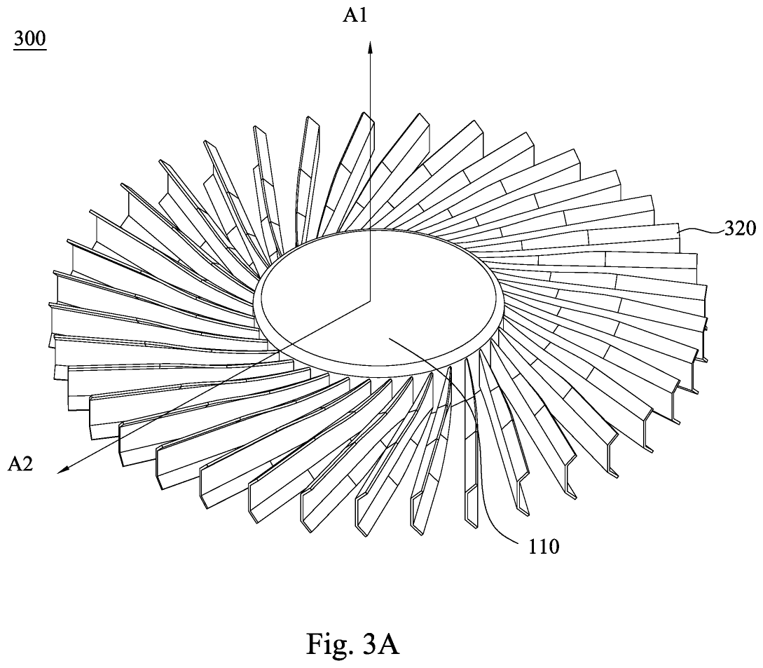

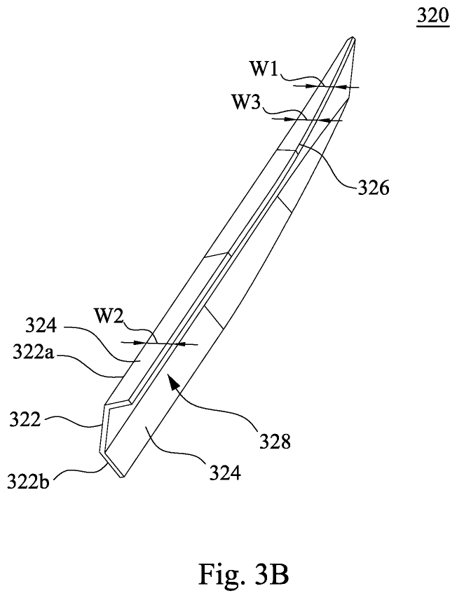

FIG. 3A schematically illustrates a top view of a fan 300, according to another embodiment of the present disclosure. FIG. 3B schematically illustrates one of the blades 320 of the fan 300 in FIG. 3A, according to another embodiment of the present disclosure. References are made to FIG. 3A and FIG. 3B, in this embodiment, fan 300 includes a fan hub 110 and multiple blades 320. Two extended blade portions 324 extend from a first edge 322a and a second edge 322b of the blade body 322 of the blade 320 respectively. The formation of the blade body 322 and the two extended blade portions 324 of the blade 320 may be similar to the embodiment shown in FIG. 1A and FIG. 1B. In this embodiment, the two extended blade portions 324 has a first width W1 that is adjacent to the fan hub 110 and a second width W2 that is away from the fan hub 110. The second width W2 is larger than the first width W1. Similar to the embodiment shown in FIG. 1A and FIG. 1B, the first width W1 and the second width W2 are connected to each other through a continuous surface 326. A width W3 of the continuous surface 326 is between the first width W1 and the second width W2.

References are made to FIG. 3A and FIG. 3B, in this embodiment, an angle between the two extended blade portions 324 and the blade body 322 is larger than 90 degrees. The air collection space 328 formed between the two extended blade portions 324 and the blade body 322 is smaller than the air collection space 128 discussed in FIG. 1B. However, in a sectional view that is perpendicular to an axial direction A1 of the fan hub 110, the angle between the two extended blade portions 324 and the blade body 322 is larger than 90 degrees. Therefore, the wind field near the first edge 322a and the second edge 322b is smoother. A smooth wind field may help to reduce the formation of turbulence and thus lower the noise produced by the blades 320 during the rotation.

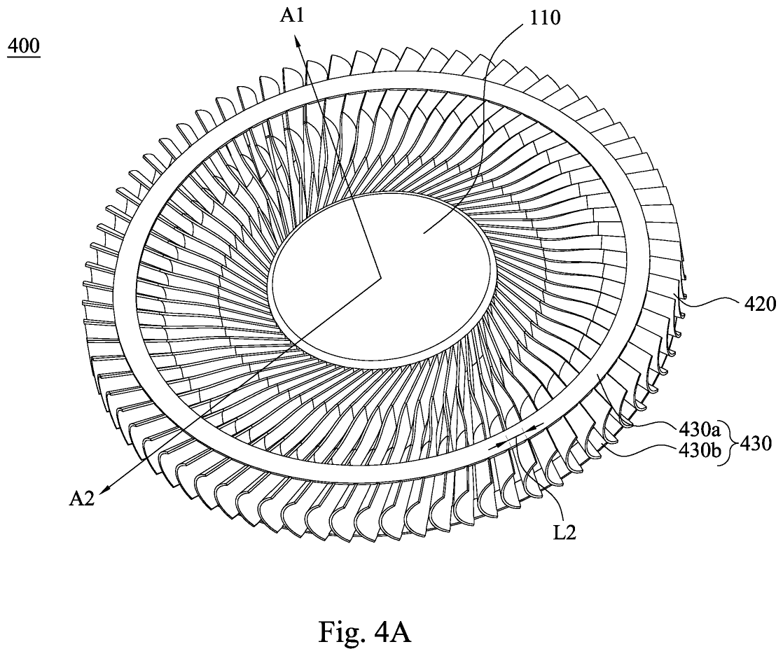

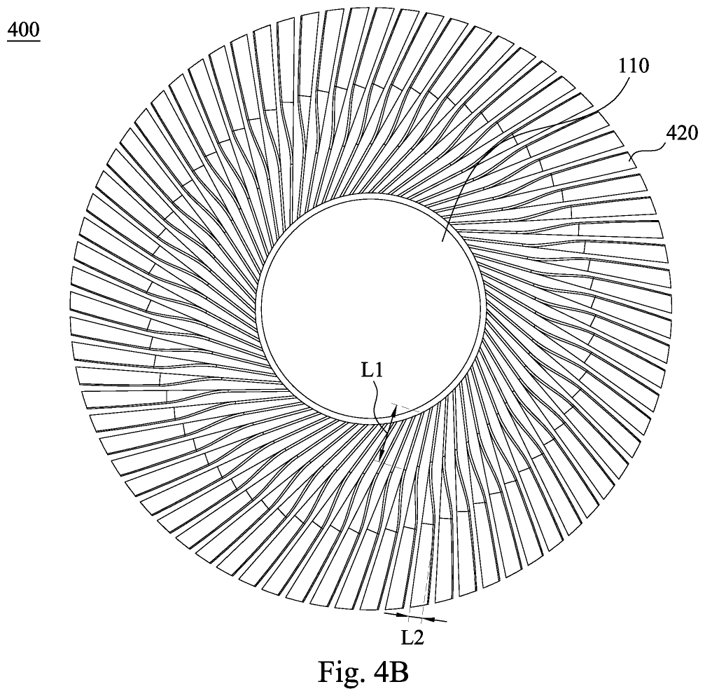

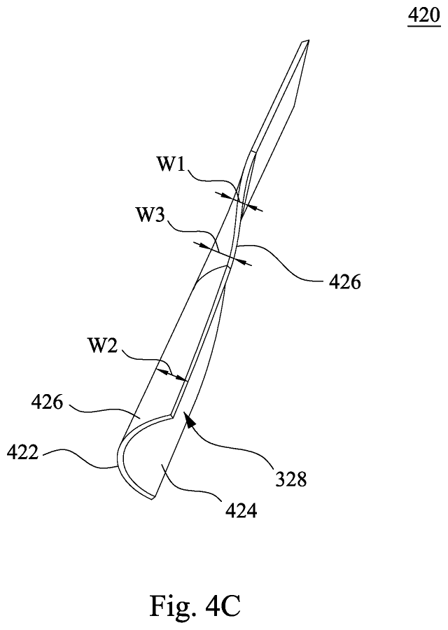

FIG. 4A schematically illustrates a fan 400 with a limitation structure 430, according to one embodiment of the present disclosure. FIG. 4B schematically illustrates a top view of the fan 400 after removing the limitation structure 430 in FIG. 4A, according to one embodiment of the present disclosure. FIG. 4C schematically illustrates one of the blades 420 of the fan 400 in FIG. 4B, according to one embodiment of the present disclosure. References are made to FIG. 4A, FIG. 4B, and FIG. 4C. In this embodiment, fan 400 includes a fan hub 110 and multiple blades 420. The formation of the blade body 422 and two extended blade portions 424 of the blade 420 may be similar to the embodiment shown in FIG. 1A and FIG. 1B. The structure of this embodiment is similar to the embodiment shown in FIG. 1A and FIG. 1B. However, the difference between them is that in a sectional view that is perpendicular to an axial direction A1 of the fan hub 110, the two extended blade portions 424 and the blade body 422 form a smoothed curved surface. Specifically, the two extended blade portions 424 are two curved surfaces and connect to the blade body 422 respectively. The two extended blade portions 424 then extend towards the rotation direction of fan 400. In the embodiment shown in FIG. 4C, the two extended blade portions 424 and the blade body 422 form an arc outline in a sectional view that is perpendicular to an axial direction A1 of the fan hub 110, and the arc outline has a single curvature. An opening of the arc outline is facing the rotation direction of fan 400. However, in other embodiments, the arc outline with single curvature may be replaced by an arc outline with multiple curvatures. The arc outline formed by the two extended blade portions 424 and the blade body 422 smoothed the wind field near by two sides of the blade 420, thus reducing the formation of turbulence. The arc outline also defines the shape of the air collection space 428.

References are made to FIG. 4A, FIG. 4B, and FIG. 4C, in some embodiments, a first distance L1 is between at least one of the two extended blade portions 424 and the fan hub 110. Specifically, as discussed in FIG. 1A and FIG. 1B, in FIG. 4A, FIG. 4B, and FIG. 4C, the second width W2 of the two extended blade portions 424 that is away from the fan hub 110 is still larger than the first width that is adjacent to the fan hub 110. A continuous surface 426 connects the first width W1 and the second width W2. The size of a width W3 of the continuous surface 426 is between the first width W1 and the second width W2. In the first distance L1, the blade body 422 extends as a plane along the axial direction A1 of fan 400. Specifically, by setting the first distance L1, the air inlet of fan 400 may be maximized, since no other structure (such as extended blade portion 424) is blocking the airflow in the first distance L1. By cooperating with the two extended blade portions 424 that are arranged on the side away from the fan hub 110, the airflow entering fan 400 may move into the air collection space 428 and then be thrown out toward the end of the blade 420. Therefore, fan 400 may have its maximum air volume, and at the same time fan 400 may reduce the formation of turbulence at the upper and lower sides of the blade 420, which solves the noise problem of fan 400.

References are made to FIG. 4A, FIG. 4B, and FIG. 4C. In some embodiments, fan 400 further includes a limitation structure 430. The limitation structure 430 connects the at least one of the blades 420 and another adjacent blade 420. A second distance L2 is formed between the at least one of the blades 420 and the adjacent blade 420. In some embodiments, the limitation structure 430 is a ring shape structure. Specifically, as the embodiment shown in FIG. 4A, the upper edge (such as the first edge 122a, 322a in the discussed embodiments shown in FIG. 1B and FIG. 3B) of the blade body 422 of all of the blades 420 in fan 400 are connected by the first limitation structure 430a. In addition, the lower edge (such as the second edge 122b, 322b in the discussed embodiments shown in FIG. 1B and FIG. 3B) of the blade body 422 of all of the blades 420 in fan 400 are connected by the second limitation structure 430b. The limitation structure 430 limits the distance between each blade 420 equal to the second distance L2, thus preventing the distance between the blades 420 from changing during the operation of fan 400. Hence, the air volume and the wind field of fan 400 will not be affected by the distance between the blades 420.

In the aforementioned embodiments of the present disclosure, in the fan of the present disclosure, through the two extended blade portions located on the upper edge and the bottom edge of the fan, the airflow will not run off from the upper edge and the bottom edge, and the amount of airflow and heat dissipation efficiency may be increased. The angle between the extended blade portions and the blade body may be larger than or equal to 90 degrees. The angle may adjust the wind field near the blades, and further decrease the noise produced by the turbulence of the fan. In addition, the extended blade portion located on a side of the blade body that is away from the fan hub may increase the amount of airflow while maintaining the air intake of the fan. The limitation structure may be located on the blade body and connects the first edge and the second edge thus preventing the distance between the blades changes during the operation to maintain the wind field of the fan.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the invention. In view of the foregoing, it is intended that the present disclosure cover modifications and variations of this invention provided they fall within the scope of the following claims.

1. A fan, comprising:
a fan hub; and
a plurality of blades, wherein at least one of the blades comprises:
a blade body; and
two extended blade portions connecting a first edge and a second edge that is opposite to the first edge of the blade body,
wherein in a top view, at least one of the two extended blade portions has a first width that is adjacent to the fan hub and a second width that is away from the fan hub, the second width is greater than the first width, the second width and the first width are connected to each other through a continuous surface, and a width of the continuous surface increases away from the first width.

2. The fan of claim 1, wherein the blade body extends along a radial direction of the fan hub, and the two extended blade portions extend along a rotation direction of the fan.

3. The fan of claim 1, wherein the blade body has a trench along a radial direction of the fan hub, and an opening of the trench is facing a rotation direction of the fan.

4. The fan of claim 1, wherein in a cross-sectional view that is perpendicular to an axial direction of the fan hub, an angle between the two extended blade portions and the blade body is greater than or equal to 90 degrees.

5. The fan of claim 1, wherein the two extended blade portions and the blade body form a smoothed curved surface, and the smoothed curved surface has an arc outline in a cross-sectional view that is perpendicular to an axial direction of the fan hub.

6. The fan of claim 5, wherein a first distance is between at least one of the two extended blade portions and the fan hub.

7. The fan of claim 1, wherein a side of the at least one blades that is away from the fan hub extends along an axial direction of the fan hub and connects the first edge and the second edge, and the second width is located where the at least one of the two extended blade portions and the side are connected.

8. The fan of claim 1, wherein the blade body and the two extended blade portions form an air collection space, and the air collection space of the at least one of the blades extends along a radial direction of the fan.

9. The fan of claim 8, wherein an opening of the air collection space is facing a rotation direction of the fan.

10. The fan of claim 1, further comprising a limitation structure, wherein the limitation structure connects the at least one of the blades and another adjacent blade, and a second distance is formed between the at least one of the blades and the another adjacent blade.
